(19) United States
(12) Patent Application Publication
(10) Pub. No.: US 2015/0205079 A1
(43) Pub. Date: Jul. 23, 2015

(54) TERAHERTZ BAND WAVELENGTH PLATE AND TERAHERTZ WAVE MEASUREMENT DEVICE

(71) Applicant: AISIN SEIKI KABUSHIKI KAISHA, Kariya-shi (JP)

(72) Inventors: Jun TAKAYANAGI, Nagoya-shi (JP); Masaya NAGAI, Toyonaka-shi (JP)

(73) Assignee: AISIN SEIKI KABUSHIKI KAISHA, Kariya-shi (JP)

(21) Appl. No.: 14/597,336

(22) Filed: Jan. 15, 2015

(30) Foreign Application Priority Data
Jan. 17, 2014 (JP) 2014-006805

(51) Int. Cl. G02B 13/14; G01N 21/55; G02B 5/30

(52) U.S. Cl. CPC G02B 13/14; G02B 5/3083; G02B 5/3041; G01N 21/55; G01N 2201/06113; G01N 2201/068

(57) ABSTRACT

A terahertz band wavelength plate includes: a first metallic plate; and a second metallic plate which is disposed opposite the first metallic plate, wherein at least one of the first and second metallic plates has a periodic dielectric constant distribution in which a plasmon is excited.

### CROSS REFERENCE TO RELATED APPLICATIONS

This application is based on and claims priority under 35 U.S.C. §119 to Japanese Patent Application 2014-006805, filed on Jan. 17, 2014, the entire contents of which are incorporated herein by reference.

### TECHNICAL FIELD

This disclosure relates to a terahertz band wavelength plate and a terahertz wave measurement device, and more specifically to a terahertz band wavelength plate which imparts a predetermined phase difference between orthogonal polarization components of a terahertz wave, and a terahertz wave measurement device.

### BACKGROUND DISCUSSION

A terahertz technology is a technology particularly attracting attention in recent years in security, medical, and biotechnology industries and the like starting with a nondestructive inspection and a transmission inspection. In the related art, use of a terahertz wave is limited as there is neither a generation source nor a detection device with good quality. However, generation or detection of the terahertz wave has been facilitated accompanied by recent technological innovation, and the terahertz technology has been applied in various industrial fields.

However, development related to an optical element used in an optical system of the terahertz wave is still delayed. The terahertz wave indicates an electromagnetic wave of which the frequency is generally in a terahertz order (0.1 THz to several tens THz) and corresponds to an intermediate band between an optical wave and an electric wave. The terahertz wave has a longer wavelength and a wide band than those of a laser beam, and therefore, the optical element used in the laser beam in the related art cannot be used for the terahertz wave.

A wire grid has been widely used in the related art as a polarization device of the terahertz wave band. WO 2007/138813 (Reference 1) discloses a wire grid with metallic wires arranged at even intervals. The wire grid absorbs and reflects a polarization component of an incident wave which is parallel to the wire, and transmits a perpendicular polarization component, and therefore, it is possible to obtain only a polarization component which is perpendicular to the wire as an output wave.

However, the wire grid is a polarizer extracting light in a specific polarized direction, and does not function as a wavelength plate that rotates polarized light itself. For example, the wire grid cannot be used as a ¼ wavelength plate that creates elliptically polarized light from linearly polarized light. It is possible to rotate the polarized direction of the linearly polarized light by combining two wire grids at deviated angles. However, it is difficult to obtain practical emission intensity since most of incident light beams is absorbed and reflected. For this reason, the wire grid is not suitable for being used as the wavelength plate.

J. Masson and G. Gallot, “Terahertz achromatic quarter-wave plate”, Opt. Lett., Vol. 31, No. 2, pp. 265-267, 2006 (Non-patent Reference 1) discloses use of a wavelength plate having a structure in which a plurality of birefringence crystals are stacked, in a terahertz wave. It is possible to realize a wide-band quartz crystal wavelength plate by increasing the number of quartz crystal plates formed of the birefringence crystals.

In addition, M. Born and E. Wolf, Principles of Optics, 6th Ed. (Cambridge University Press, 1997) (Non-patent Reference 2) discloses a so-called “Fresnel rhomb”. The Fresnel rhomb is a wavelength plate used in an optical area. It is possible to use the Fresnel rhomb as the wavelength plate even in the terahertz wave band if it is made of materials such as high resistance silicon through which the terahertz wave is well transmitted.

The quartz crystal wavelength plate disclosed in Non-patent Reference 1 has a structure in which six quartz crystal plates having thicknesses of 3 mm to 8 mm are stacked, and the thickness of the element of a bulk portion is greater than or equal to 30 mm as a whole. The quartz crystal wavelength plate expands the bandwidth by stacking the plurality of quartz crystal plates, and therefore, the whole thickness of the element is necessarily made thick in order to secure the bandwidth. In a case where the thickness of the element is about several tens of mm, since it is impossible to ignore loss in the quartz crystal plate, the quartz crystal wavelength plate disclosed in Non-patent Reference 1 has a defect in that insertion loss is large while in a wide band.

In addition, the Fresnel rhomb disclosed in Non-patent Reference 2 is a rhombic prism, and realizes a function as a wavelength plate by wholly reflecting incident light from the inside of the prism by a plurality of times. However, in the Fresnel rhomb, since the optical axes of incident light and emission light are deviated, it is necessary to precisely adjust the optical axes during arrangement, and it is difficult to obtain an output completely coaxial with an input since the incident light is reflected by the plurality of times. For this reason, it is not easy to handle the Fresnel rhomb during use, and therefore, it cannot be said that the Fresnel rhomb is sufficiently practical. In addition, the beam diameter of the terahertz wave is generally greater than that of a laser beam. In the Fresnel rhomb, the large terahertz wave needs to be reflected by a plurality of times, and therefore, it is difficult to make the size of the Fresnel rhomb small and to make the thickness thereof thin.

### SUMMARY

Thus, a need exists for a wavelength plate of a terahertz wave band which is not suspectable to the drawback mentioned above.

An aspect of this disclosure is directed to a terahertz band wavelength plate which is formed by stacking a plurality of metallic plates with a constant gap in parallel. The metallic plate has a periodic structure in a terahertz wavelength order, and imparts different phase changes to a polarization component parallel to the metallic plate, and to a polarization component perpendicular to the metallic plate, to a terahertz wave incident on a stacked side plane of the wavelength plate so as to emit the terahertz wave.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a perspective view for illustrating a structure of a terahertz band wavelength plate according to an embodiment disclosed here and FIG. 1B is a view for illustrating a method of stacking metallic plates of the terahertz band wavelength plate according to an embodiment disclosed here;

FIG. 2A is a perspective view for illustrating a structure of the terahertz band wavelength plate according to an embodiment disclosed here and FIG. 2B is a partially enlarged view (top view) of a periodic structure according to an embodiment disclosed here;

FIG. 3 is a perspective view showing a periodic structure according to an embodiment disclosed here;

FIG. 4 is a graph for illustrating frequency dependences of a group velocity _{VG} and a phase velocity _{Vp} in parallel plate waveguides;

FIGS. 5A and 5B are graphs showing transmission properties of a terahertz band wavelength plate according to an embodiment disclosed here;

FIGS. 6A and 6B are graphs showing transmission properties of a terahertz band wavelength plate according to an embodiment disclosed here;

FIGS. 7A and 7B are graphs showing transmission properties of a terahertz band wavelength plate according to an embodiment disclosed here when the device is manufactured so as to be a ¼ wavelength plate;

FIG. 8 is a schematic configuration diagram of a measurement device according to an embodiment disclosed here; and

FIG. 9 is a schematic configuration diagram of a measurement device according to an embodiment disclosed here.

### DETAILED DESCRIPTION

Hereinafter, embodiments disclosed here will be described with reference to accompanying drawings, but the embodiment disclosure here is not limited to the embodiments. The elements having the same function in the drawings to be described below are given the same reference numerals and the repeated description will be omitted.

In the embodiments disclosed here, the “terahertz wave” indicates an electromagnetic wave of which the frequency is around 1 THz (100 GHz to 10 THz) and the “terahertz wavelength order” indicates a wavelength which is almost the same (30 μm to 3 mm) as the wavelength of the terahertz wave. The definitions are not intended to limit the terahertz wave and the terahertz wavelength order and simply show a standard. Accordingly, even when the terahertz wave and the terahertz wavelength order are deviated from the ranges defined above, they are included in the embodiments disclosed here as long as they can be called the terahertz wave and the terahertz wavelength order. In addition, the “wavelength plate” is a polarization element that imparts a predetermined phase difference between orthogonal polarization components. Particularly, a wavelength plate of which the phase difference is π (180 degrees) is called ½ wavelength plate and a wavelength plate of which the phase difference is π/2 (90 degrees) is called ¼ wavelength plate.

### First Embodiment

First, a configuration of a terahertz band wavelength plate according to the embodiment will be described.

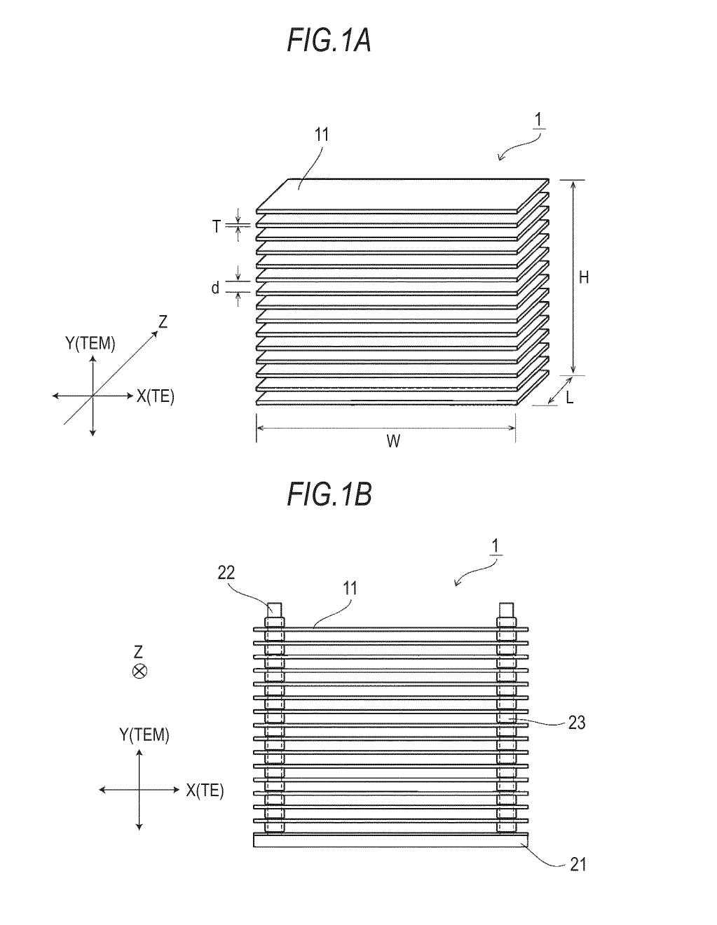

FIG. 1A is a view showing a basic structure of the terahertz band wavelength plate according to the embodiment. The terahertz band wavelength plate 1 is a wavelength plate having a plurality of metallic plates 11. The metallic plates 11 are uniform metallic plates having a thickness without high/low pitch and unevenness shape. The metallic plates 11 are stacked in parallel along a Y-axis direction (stacking direction) with a constant gap d and constitute the terahertz band wavelength plate 1 as a whole. The terahertz wave is perpendicularly incident on a front plane (X-Y plane) of the terahertz band wavelength plate 1, and is emitted from a back plane of the terahertz band wavelength plate facing the front plane thereof after transmitting the wavelength plate. That is, in FIG. 1A, the terahertz wave is incident from a Z-axis direction and is emitted by being propagated in terahertz band wavelength plate 1 in the Z-axis direction.

It is preferable that the size (width W×height H) of a stacked side plane of the terahertz band wavelength plate 1 which becomes a light receiving plane be greater than the beam diameter of a terahertz wave to be used. The width W of the terahertz band wavelength plate 1 is simply determined by the length of a metallic plate 11, and therefore, the length of the metallic plate 11 may be set in accordance with the incident beam diameter. In contrast, the installation gap d between the metallic plates 11 is determined by the amount of phase change required for the wavelength plate (to be described later), and therefore, the height H of the terahertz band wavelength plate 1 can be adjusted by changing the number of sheets of the metallic plates 11 which are stacked by the determined gap d.

In general, the beam diameter of the terahertz wave is about several tens of mm, and therefore, in some cases, the beam diameter becomes greater than the light receiving plane of an optical element. In such a case, adjustments such as focusing a beam using a lens, and performing coupling are necessary. However, in the present embodiment, it is possible to change the size of the light receiving plane depending on the number of sheets of the metallic plates 11 to be stacked. Therefore, the size of the light receiving plane may be set to a size of the element which is adapted to a beam diameter to be used, and it is not necessary to adjust the beam diameter. In the present embodiment, the size of the terahertz band wavelength plate 1 is set to width W of 50 mm×height H of 50 mm×length L of 10 mm.

Even when the size of the light receiving plane of the terahertz band wavelength plate 1 is smaller than the beam diameter of the terahertz wave to be used, this does not affect the essential function of the embodiment disclosed here. As will be described later in detail, the essential function of the embodiment disclosed here refers to causing a predetermined phase difference between orthogonal polarization components of the terahertz wave.

FIG. 1B is a front view of a stacked side plane (X-Y plane) of the terahertz band wavelength plate 1 shown in FIG. 1A, and shows a method of stacking the metallic plates 11. Spacers 23 between the metallic plates 11 are pinched at both ends of the metallic plates 11, and the installation gap d between the metallic plates 11 is secured by the spacers 23. The metallic plates 11 have holes, which are made at both ends thereof, and are fixed by support poles 22 passing therethrough. The support poles 22 are installed perpendicular to a support pole-supporting base 21 which is provided in the lowermost portion of the terahertz band wavelength plate 1.

Next, a principle of the terahertz band wavelength plate according to the present embodiment will be described.

The terahertz band wavelength plate 1 shown in FIG. 1A has a structure in which a plurality of metallic plates 11 are disposed in parallel. The structure is equivalent to a structure in which a plurality of parallel plate waveguides are stacked, and therefore, all of the gaps of the metallic plates 11 function as the parallel plate waveguides with respect to an incident wave in a parallel direction of the metallic plates 11.

The parallel plate waveguides are waveguides for an electromagnetic wave which is used in the related art. Polarization components parallel to the plate are propagated in the waveguides in a TE mode, and polarization components perpendicular to the plate are propagated in the waveguides in a TEM mode. The TE mode refers to as a state in which there is no electric field component in an advancing direction of the electromagnetic wave, but there is an electric field component in a direction orthogonal to the advancing direction thereof. The TEM mode refers to as a state in which there is neither an electric field component nor a magnetic field component in the advancing direction thereof, but there is an electric field component and a magnetic field component in a direction orthogonal to the advancing direction thereof. In FIG. 1A, the X-axis corresponds to a vector direction of the electric field component in the TE mode, and the Y-axis corresponds to a vector direction of the electric field component in the TEM mode. Accordingly, when the terahertz wave is incident on the stacked side plane (X-Y plane) of the terahertz band wavelength plate 1, the polarization components (horizontally polarized light) parallel to the metallic plates 11 can be propagated between the metallic plates 11 as the parallel plate waveguides in a Z-axis direction in the TE mode, and the polarization components (longitudinally polarized light) perpendicular to the metallic plates can be propagated between the metallic plates 11 as the parallel plate waveguides in the Z-axis direction in the TEM mode.

However, every electromagnetic wave cannot be propagated in the parallel plate waveguides, and when the half-wave length of an incident wave is greater than the gap between the plates, the incident wave is blocked and cannot be propagated. The wavelength and the frequency of the incident wave at this time are respectively called a cutoff wavelength λ_{c} and a cutoff frequency f_{c}. When the gap between the plates is set to d, the cutoff wavelength λ_{c} is represented by λ_{c}=2d. In general, it is known that a group velocity _{VG} and the phase velocity _{Vp} of horizontal polarization components being propagated in the TE mode are greatly affected as the frequency approaches the cutoff frequency f_{c}. FIG. 4 is a graph in which frequency dependences of the group velocity _{VG} and the phase velocity _{Vp} in parallel plate waveguides with 1 mm of a gap between the plates are shown by obtaining a frequency on the horizontal axis and a refractive index (n=c/v) on the longitudinal axis. A group refractive index n_{G} is represented by a dotted line and a phase refractive index n_{P} is represented by a solid line. It can be seen that the phase refractive index n_{P} becomes small as the frequency approaches the cutoff frequency f_{c} (while the phase velocity _{Vp} becomes high). In addition, when the gap d between the plates is set to be small, the cutoff frequency f_{c} becomes high, and therefore, the graph of the phase refractive index n_{P} is shifted to the right as shown by the broken line. That is, in the parallel plate waveguides, the increased amount in the phase velocity _{Vp} of the horizontally polarized light being propagated in the TE mode becomes greater as the gap d between the plates becomes smaller. In contrast, the phase velocity of the longitudinal polarization component being propagated in the TEM mode is not affected during the propagation.

### Example 1

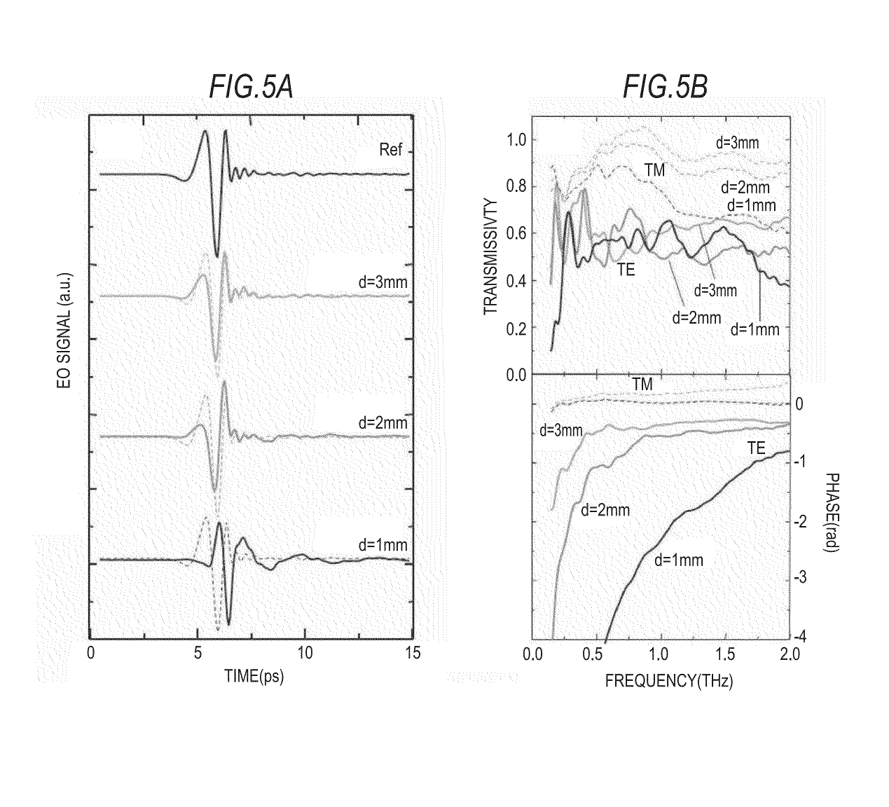

FIG. 5A is a graph showing a change in an electric field amplitude of an incident terahertz wave in the terahertz band wavelength plate 1 shown in FIG. 1A. The uppermost waveform (Ref) shows a waveform of an electric field amplitude of an incident terahertz wave as a reference. Other three waveforms are waveforms of electric field amplitudes in cases where the gaps d between the metallic plates 11 in the terahertz band wavelength plate 1 shown in FIG. 1A are respectively set to 3 mm, 2 mm, and 1 mm. The TE mode component is represented by a solid line and the TEM mode component is represented by a broken line. It can be confirmed from FIG. 5A that the phase of an output waveform in the TE mode component gradually advances (shifted to the left) as the gap d between the plates becomes smaller and that there is hardly a change in the waveform of the TEM mode component from the reference electric field (Ref) regardless of the gap d of the plates.

Spectrum information obtained by performing Fourier transform of the electric field amplitude shown in FIG. 5A is shown in FIG. 5B. The left longitudinal axis on the upper side of FIG. 5B represents transmissivity of the terahertz band wavelength plate 1, the right longitudinal axis on the lower side of FIG. 5B represents an amount of phase change after transmission, and the horizontal axis of FIG. 5B represents a frequency of an incident wave. The phase being minus indicates that the phase has advanced. It can be confirmed from FIG. 5B that there is hardly a change in the phase in the TEM mode component depending on the gap d between the plates whereas the phase in the TE mode component greatly advances as the gap d between the plates becomes smaller. In addition, it can be confirmed that the transmissivity is favorable in a wide band exceeding 2.0 THz from the cutoff frequency f_{c}.

According to the terahertz band wavelength plate 1 of the present embodiment, it is possible to impart a phase change only to the orthogonal TE mode component without influencing the TEM mode component, and therefore, it is possible to cause a phase difference between orthogonal polarization components. Furthermore, the phase difference can be controlled by the gap d or a depth length L of the metallic plates 11.

### Second Embodiment

First, the configuration of the terahertz band wavelength plate according to the present embodiment will be described.

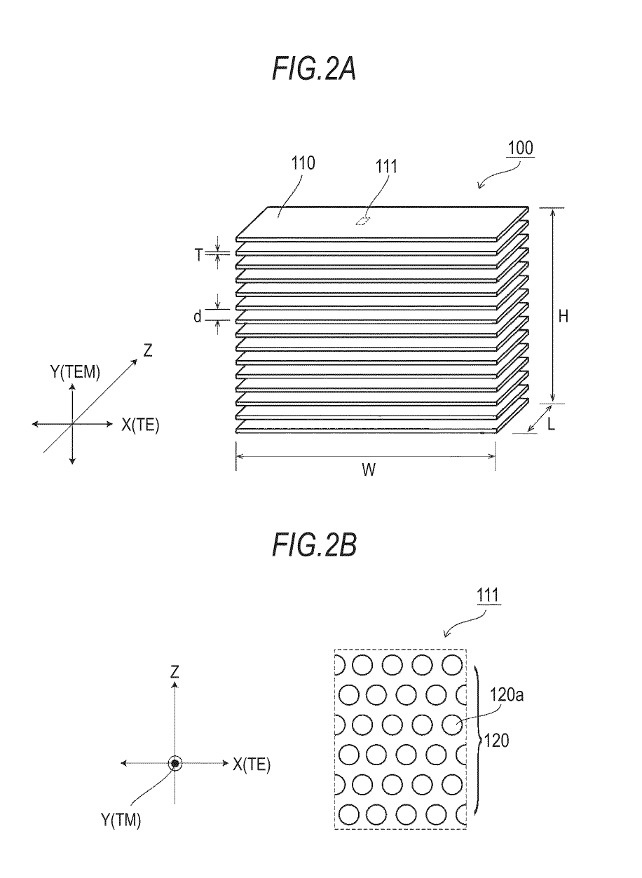

FIG. 2A is a view showing a basic structure of the terahertz band wavelength plate according to the present embodiment. The terahertz band wavelength plate 100 is a wavelength plate having a plurality of metallic plates 110. The metallic plates 110 are stacked parallel along a Y-axis direction (stacking direction) having a constant gap d and constitutes the terahertz band wavelength plate 100 as a whole. The terahertz wave is perpendicularly incident on a front plane (X-Y plane) of the terahertz band wavelength plate 100, and is emitted from a rear plane of the terahertz band wavelength plate facing the front plane thereof after transmitting the wavelength plate. That is, in FIG. 2A, the terahertz wave is incident from a Z-axis direction and is emitted by being propagated in the terahertz band wavelength plate 100 in the Z-axis direction. A method of stacking the metallic plates 110 is the same as the method shown in FIG. 1B of the first embodiment, and therefore, the repeated description will be omitted in the present embodiment.

In the terahertz band wavelength plate 100 according to the present embodiment, a periodic structure is formed on each of the metallic plates 110 in addition to the structure shown in FIG. 2A. FIG. 2B is an enlarged view of a portion 111 of a metallic plate 110 having a periodic structure 120. Each of the metallic plates 110 constituting the terahertz band wavelength plate 100 has the periodic structure 120 in which circular openings 120a in a terahertz wavelength order are periodically formed. In FIG. 2B, only the portion 111 of the metallic plate 110 is enlarged and shown in the drawing in order to facilitate the description, but the circular openings 120a are periodically formed over the entire metallic plate 110.

In the present embodiment, the periodic structure 120, in which the circular openings 120a with a diameter of 66 μm are continuously disposed at a center gap of 100 μm, is formed on a metallic plate 110 of a length of 50 mm (=W)×width of 10 mm (=L)×thickness D of 0.03 mm which is made of stainless steel. The periodic structure 120 is a structure in which it is possible to easily process the periodic structure at a gap substantially equal to the wavelength of the incident wave and maintain the strength of the plate, which are conditions suitable for manufacturing the actual device. The periodic structure of the circular openings 120a is preferable as the structure that satisfies the conditions. As a measure for creating the periodic structure, performing a surface treatment through etching, or blast processing can be considered as a technique for simply implementing the fine periodic structure in addition to electroformation. The thickness of the metallic plate 110 is preferably thin when considering the transmissivity. However, since the concave/convex condition by opening holes is one of the constituent elements of the periodic structure 120, it is preferable that the thickness of the metallic plate 110 be optimally set by matching the band of a terahertz wave to be used, or the wavelength plate with the desired amount of phase change. The material of the metallic plate 110 is preferably a material, for example, stainless steel or a copper plate, which has high conductivity. However, it is also possible to use a material having low conductivity similarly to the high conductivity material as long as the surface of the material having low conductivity is subjected to gold plating.

Next, a principle of the terahertz band wavelength plate according to the present embodiment will be described.

In the terahertz band wavelength plate 100 according to the present embodiment, the periodic structure 120 is formed on each of the metallic plates 110. The periodic structure 120 does not affect propagation of a polarized direction component (horizontally polarized light) of the incident wave which is parallel to the metallic plates 110, but affects propagation of a polarized direction component (longitudinally polarized light) of the incident wave which is perpendicular to the metallic plates 110.

When the periodic structure 120 is formed, a surface plasmon is excited on the metallic plates 110 by the incident wave. The surface plasmon is a collective oscillation of free electrons within metal, and is a surface wave being propagated in the surface of the metal. In this case, the polarized direction component perpendicular to the metallic plates 110 has an electric field component also in an advancing direction of an electromagnetic wave, and therefore, is propagated in a Z-axis direction in the metallic plates 110 not in a TEM mode, but in a TM mode. The surface plasmon becomes a surface plasmon polariton (in a state where the free electrons and the electromagnetic wave are mixed) by being combined with the electromagnetic wave. The surface plasmon polariton has a resonance frequency determined by the periodic structure 120. A phase delay is caused in the TM mode component due to a hopping phenomenon in which the electromagnetic wave in the vicinity of the resonance frequency resonates. The periodic structure 120 due to the circular opening 120a is in a best form as a structure in which it is possible to increase the resonance frequency of the plasmon, among structures which can be formed through etching using a free standing plate.

That is, the periodic structure 120 contributes to generation of surface plasmon, and is essentially a structure for periodically changing a “dielectric constant distribution of metal”. With the provision of a structure such as openings or concave/convex shapes to the metallic plates 110, it is possible to effectively manufacture metal having periodic dielectric constant from the metal having an original steady dielectric constant in the related art.

In this manner, the frequency of the plasmon is determined by the period of the dielectric constant, and the plasmon polariton resonates with the terahertz wave in the periodic structure. As a result, the delay due to the terahertz wave prolonged by the plasmon polariton is a factor causing the phase delay in the TM mode component. In addition, this phenomenon can be explained from a point of view of optics such that the periodic structure 120 is a Bragg reflector and acts as a band-stop filter for the TM mode component. That is, when the terahertz wave transmits through the band-stop filter using the periodic structure 120, the polarized direction component (longitudinally polarized light) perpendicular to the metallic plates 110 is subjected to the phase delay that changes monotonously with respect to the frequency depending on the transmission properties of a band-pass filter. The stop band frequency corresponds to the resonance frequency of the plasmon.

According to the terahertz band wavelength plate 100 of the present embodiment, it is possible to impart a phase difference which is different in orthogonal components of an incident terahertz wave due to the action of the metallic plates 110 and the periodic structure 120. The essential action of the metallic plates 110 is to propagate the terahertz wave with low loss by forming a waveguide and to impart a phase change to horizontal polarization components of the terahertz wave. In addition, the essential action of the periodic structure 120 is to excite a plasmon on the surface of the metallic plate 110 when the terahertz wave is incident, to convert the polarized direction component (longitudinal polarization component of the terahertz wave) perpendicular to the metallic plate 110 from the TEM mode to the TM mode, and to impart the phase change to longitudinal polarization components of the propagated terahertz wave. The action with respect to the longitudinal polarization component is not an action which is initially caused by stacking a plurality of metallic plates 110, but an action which is independently caused by the metallic plate 110.

Considering the above-described essential actions, at least two metallic plates 110 may be stacked, and the shapes thereof may not be the same as each other, or the metallic plates 110 may not be strictly parallel to each other. In addition, the entire metallic plate 110 to be stacked does not necessarily have the periodic structure 120. That is, it is possible to adjust the number or the shapes of the metallic plates 110 to be stacked within an allowable range in which it is possible to realize the phase difference and the transmissivity. In addition, some of the metallic plates 110 to be stacked can be set not to have the periodic structure 120.

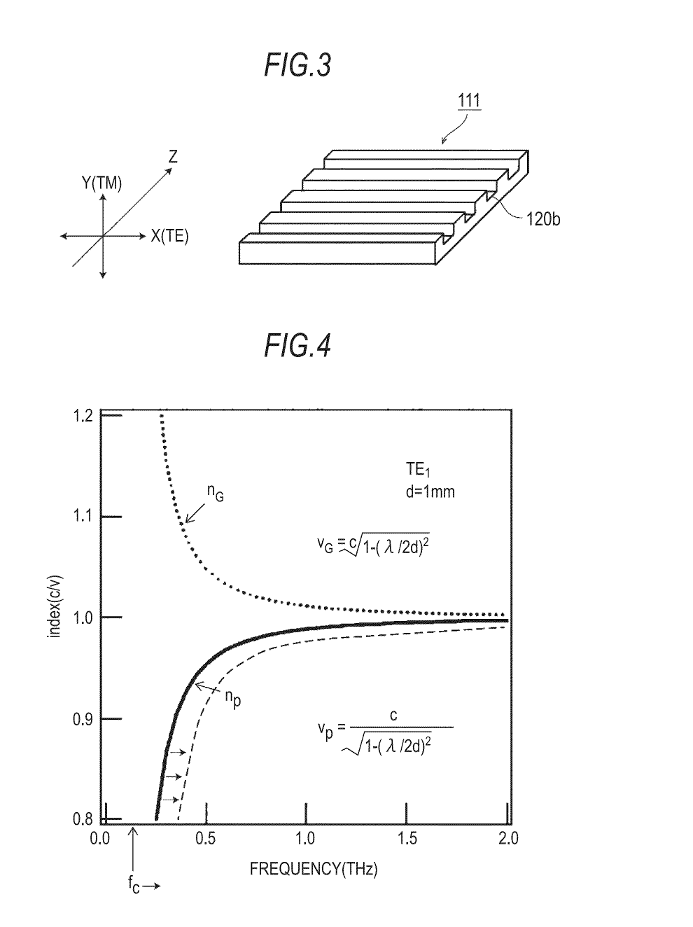

The shape of the periodic structure 120 possessed by the metallic plate 110 is not limited to the circular opening 120a, and any shape may be adopted as long as the shape thereof is a shape in which the surface plasmon is excited on the metallic plate 110 by the incident wave, that is, a shape in which a periodic structure of the dielectric constant is formed in the propagation direction of the incident wave at a gap in a wavelength order of the terahertz wave. For example, as shown in FIG. 3, the structure thereof may be a structure in which rectangular grooves 120b orthogonal (X-axis) to the propagation direction (Z-axis) are periodically dug in the propagation direction, or may be an opening having a shape (rectangular shape, star shape, or the like) other than the circular shape.

### Example 2

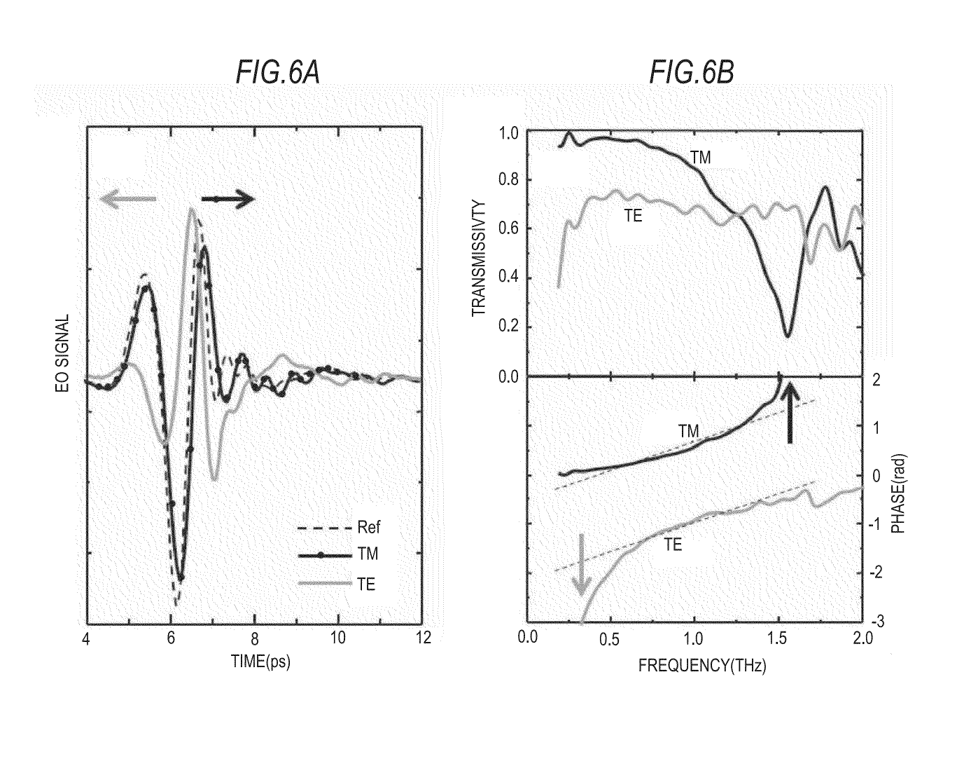

FIG. 6A is a graph showing a change in the electric field amplitude of the incident terahertz wave in the terahertz band wavelength plate 100 shown in FIGS. 2A and 2B. The gap d between the metallic plates 110 is set to 1.5 mm. The waveform (Ref) shown by a broken line shows a waveform of an electric field amplitude of an incident terahertz wave as a reference. The solid line (grey) represents a TE mode component and the solid line with black dots represents a TM mode component. It can be confirmed from FIG. 6A that the phase of the TE mode component parallel to the metallic plates 110 advances (shifted to the left) and the phase of the TM mode component perpendicular to the metallic plates 110 is delayed (shifted to the right).

Spectrum information obtained by performing Fourier transform of the electric field amplitude shown in FIG. 6A is shown in FIG. 6B. The left longitudinal axis on the upper side of FIG. 6B represents transmissivity of the terahertz band wavelength plate 100, the right longitudinal axis on the lower side of FIG. 6B represents an amount of phase change after transmission, and the horizontal axis of FIG. 6B represents a frequency of an incident wave. The minus phase indicates that the phase is delayed and the plus phase indicates that the phase advances. In regard to the phase change in the TE mode component and the TM mode component, it can be confirmed that the phase in the TM mode component is monotonously delayed as the frequency in the TM mode component becomes high as it approaches a resonance plasmon frequency whereas the phase in the TE mode component advances monotonously as the frequency becomes low as it approaches the cutoff frequency. In addition, in regard to the transmissivity, it can be confirmed that the transmissivity is favorable in a band of 0.5 THz to 1.5 THz between the cutoff frequency and the resonance plasmon frequency.

A noticeable fact in FIG. 6B is that the inclinations of the graphs of the phase changes with respect to the frequencies of the TE mode component and the TM mode component are substantially the same as each other and the difference in the amount of phase change is almost constant in a wide frequency band. The terahertz band wavelength plate of the present embodiment can impart a constant phase difference between orthogonal polarization components in the wide band using such characteristics. Furthermore, the phase difference in the amount of phase change which can be imparted to the TE mode component and the TM mode component can be arbitrarily changed depending on the cutoff frequency and the resonance plasmon frequency. As is described above, the cutoff frequency and the resonance plasmon frequency can be determined by the gap between the stacked metallic plates constituting the terahertz band wavelength plate, and the periodic structure possessed by the metallic plates. Accordingly, it is possible to realize the ¼ wavelength plate and the ½ wavelength plate by designing the device such that the phase difference becomes a ¼ wavelength and ½ wavelength.

### Example 3

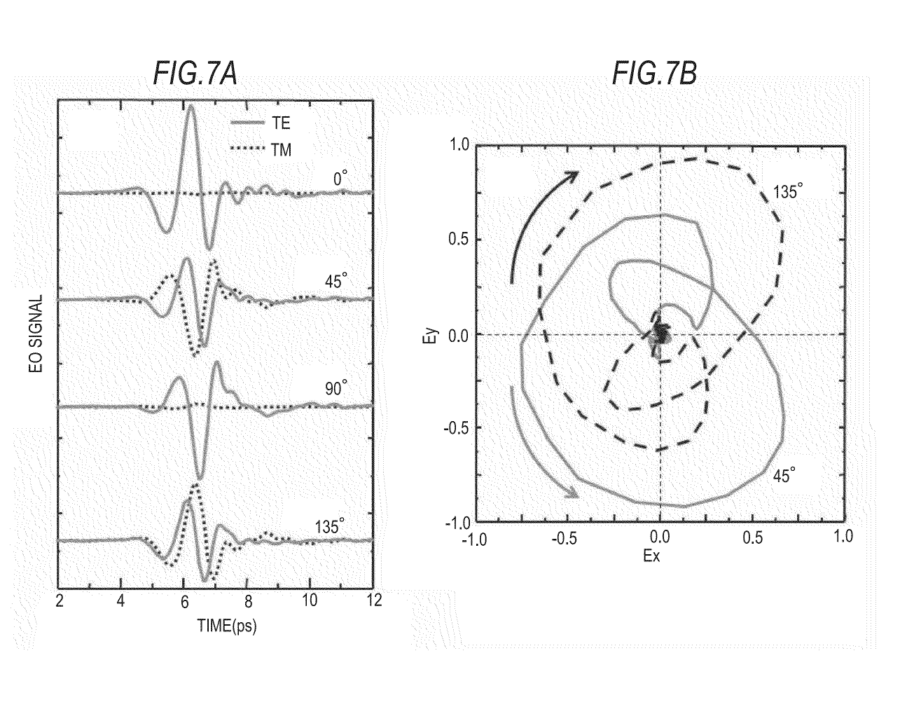

FIG. 7A is a graph showing transmission properties of the terahertz band wavelength plate 100 in which the device is manufactured such that the phase difference becomes a ¼ wavelength plate. Terahertz waves of linearly polarized light are input such that the angles of the wavelength plate in a polarized direction become 0 degree, 45 degrees, 90 degrees, and 135 degrees, and the output waveforms are observed. Two graphs at each angle show electric field amplitudes (solid line: TE mode, broken line: TM mode) of orthogonal polarization components of the output waveforms. It can be confirmed from FIG. 7A that in the cases of the angles of 0 degree and 90 degrees, the phases change while maintaining the incident wave to be linearly polarized, and in the cases of the angles of 45 degrees and 135 degrees, a phase difference is caused between the orthogonal polarization components of the incident wave and the output becomes circular polarization light. FIG. 7B is a graph showing electric field amplitudes of orthogonal polarization components of the output waveforms in the cases where the angles of the wavelength plates in the polarized direction are 45 degrees and 135 degrees. It can be confirmed from FIG. 7B that the terahertz waves after transmission become circular polarization light beams.

According to the terahertz band wavelength plate 100 shown in FIGS. 2A and 2B, it is possible to impart different phase changes to the polarized direction component (TE mode) of the incident wave which is parallel to the metallic plates 110, and to the polarized direction component (TM mode) of the incident wave which is perpendicular to the metallic plates 110. Furthermore, it is possible to impart a constant phase difference between orthogonal polarization components in the wide band since the difference in each of the phase changes is constant regardless of the band.

The data of the frequency within a range up to 2.0 THz are shown in FIGS. 5 and 6. However, the embodiments are not limited to this frequency band, and can be arbitrarily implemented at a higher band by designing the metallic plates 110 and the periodic structure 120 in accordance with the required band.

### Third Embodiment

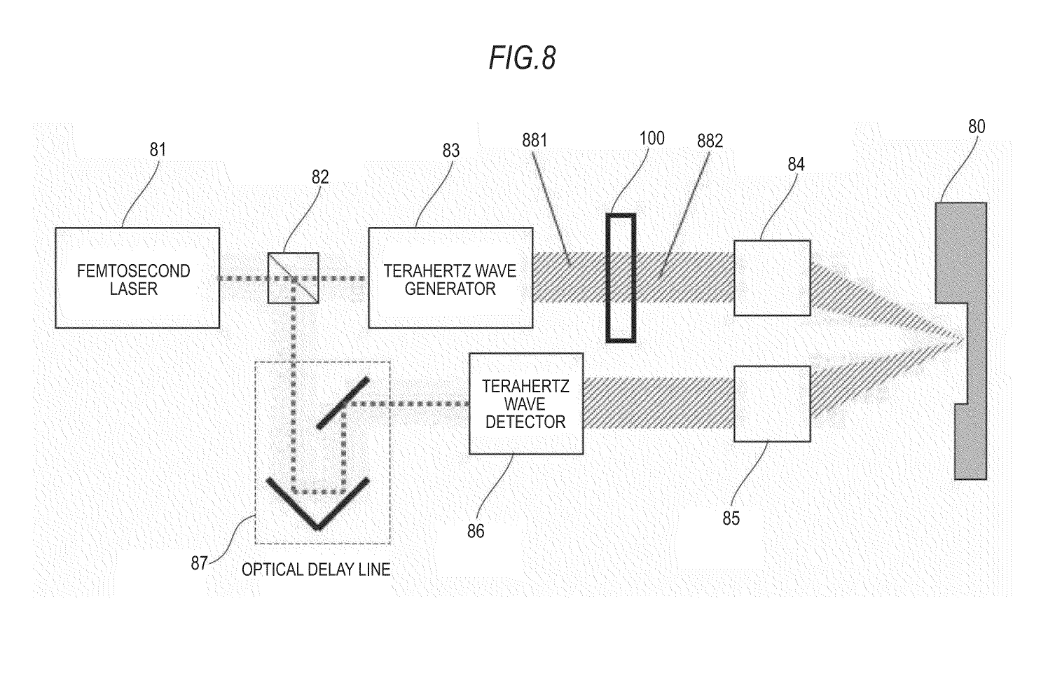

FIG. 8 is a schematic configuration diagram of a measurement device for observing a minute change in a depth direction using a terahertz wave. The terahertz wave measurement device according to the present embodiment includes a femtosecond laser 81, a beam splitter 82, a terahertz wave generator 83, a terahertz wave condensing system 84, a terahertz wave collimating system 85, a terahertz wave detector 86, an optical delay line 87, and a terahertz band wavelength plate 100. In the terahertz band wavelength plate 100, the device is designed so as to be a ¼ wavelength plate. A parabolic mirror or a lens or the like is used in the terahertz wave condensing system 84 and the terahertz wave collimating system 85.

A laser beam emitted from the femtosecond laser 81 is divided into two laser beams by the beam splitter 82. One of the laser beams is incident on the terahertz wave generator 83 as a laser for generating a terahertz wave, and the other one of the laser beams is incident on the terahertz wave detector 86 through a mirror or the like as a laser for detecting a terahertz wave. The terahertz wave generator 83 can generate a linearly polarized terahertz wave 881 from the incident laser beam. The terahertz wave 881 of linearly polarized light which is emitted from the terahertz wave generator 83 is converted into a terahertz wave 882 of elliptically polarized light by the terahertz band wavelength plate 100. The terahertz wave 882 converted into the elliptically polarized light is condensed by the terahertz wave condensing system 84, and is then emitted to an object to be measured 80.

A terahertz wave reflected from the object to be measured 80 is collimated again by the terahertz wave collimating system 85, and is then incident on the terahertz wave detector 86. The terahertz wave detector 86 can detect an amplitude for each polarization component of the reflected terahertz wave. When measuring the terahertz wave, a timing, at which the terahertz wave reflected by a reference measurement surface of the object to be measured 80 is incident on the terahertz wave detector 86, and a timing, at which the other laser beam divided by the beam splitter 82 is incident on the terahertz wave detector 86 are previously adjusted to be coincident with each other using the delay line 87. By adjusting the timings in this manner, when the object to be measured 80 is slightly deviated from the reference measurement surface in the depth direction, the timings at which the reflected terahertz wave and the femtosecond laser incident on the terahertz wave detector 86 are slightly deviated from each other. The terahertz wave after transmitting the terahertz band wavelength plate 100 becomes the elliptically polarized light, and therefore, the deviation of the timing can be detected as a deviation of a polarization state. This measurement method can be utilized for the purpose of measuring the shape of a surface of an object on an opposite side of a wall which is invisible to humans and is transparent in a terahertz wave band.

### Fourth Embodiment

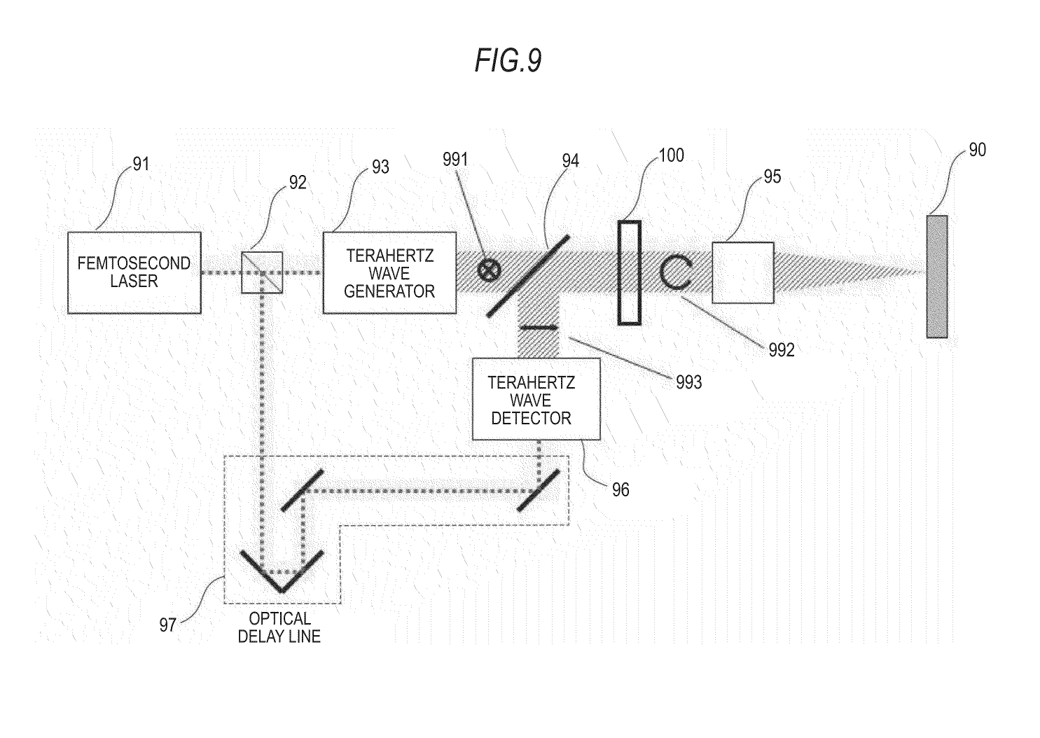

FIG. 9 is a schematic configuration diagram for illustrating a measurement device in which the incident angle of the terahertz wave is perpendicular to an object to be measured 90. The terahertz wave measurement device according to the present embodiment includes a femtosecond laser 91, a beam splitter 92, a terahertz wave generator 93, a polarizer 94, a terahertz wave condensing/collimating system 95, a terahertz wave detector 96, an optical delay line 97, and a terahertz band wavelength plate 100. In the terahertz band wavelength plate 100, the device is designed so as to be a ¼ wavelength plate. A parabolic mirror or a lens or the like is used in the terahertz wave condensing/collimating system 95. An incident optical axis of a terahertz wave incident on the object to be measured 90 and an emission optical axis of a terahertz wave reflected from the object to be measured 90 are coaxial.

The laser beam emitted from the femtosecond laser 91 is divided into two laser beams by the beam splitter 92. One of the laser beams is incident on the terahertz wave generator 93 as a laser for generating a terahertz wave, and the other one of the laser beams is incident on the terahertz wave detector 96 through a mirror or the like as a laser for detecting a terahertz wave. The terahertz wave generator 93 can generate a terahertz wave 991 of longitudinally polarized light from the incident laser beam. The polarizer 94 is provided at an angle at which a total energy with respect to the terahertz wave 991 of longitudinally polarized light is transmitted. It is possible to use, for example, a wire grid or the like is used as the polarizer 94. Every terahertz wave 991 of longitudinally polarized light which is emitted from the terahertz wave generator 93 is transmitted through the polarizer 94, and is converted into terahertz waves 992 of elliptically polarized light by the terahertz band wavelength plate 100. The terahertz wave 992 converted into the elliptically polarized light is condensed by the terahertz wave condensing/collimating system 95, and is then emitted to the object to be measured 90.

A terahertz wave reflected from the object to be measured 90 is collimated again by the terahertz wave condensing/collimating system 95, is transmitted again through the terahertz band wavelength plate 100, and is then incident again on the polarizer 94. The terahertz wave reflected by the terahertz band wavelength plate 100 returns to the linearly polarized light again from the elliptically polarized light. However, the polarized direction becomes a horizontally polarized light which is rotated by 90 degrees compared to before every terahertz wave is transmitted through the polarizer 94. Accordingly, every reflected terahertz wave 993 of the horizontally polarized light is reflected by the polarizer 94, and is incident on the terahertz wave detector 96. The method of detecting the terahertz wave performed in the terahertz wave detector 96 is the same as the detection method in the above-described third embodiment, and therefore, the repeated description in the present embodiment will be omitted.

In a terahertz wave spectroscopic device or a time-of-flight tomography device using a terahertz wave pulse, in many cases, a terahertz wave is incident on an object to be measured at a certain angle. This is because when the terahertz wave is perpendicularly incident on the object to be measured, the incident terahertz wave and the reflected terahertz wave are coaxial, and therefore, it is necessary to separate the terahertz waves. It is possible to branch the terahertz waves if a high resistance silicon substrate, a pellicle mirror, or the like is used as the beam splitter, but at this time, most of the energy of the terahertz waves is lost, and therefore, the detection sensitivity deteriorates. In contrast, the terahertz wave measurement device according to the present embodiment includes a terahertz band wavelength plate 100 which functions as the ¼ wavelength plate, and the terahertz band wavelength plate 100 is disposed between the object to be measured 90 and the polarizer 94, and therefore, it is possible to branch the incident terahertz wave and the reflected terahertz wave without losing any energy.

The wavelength plate of the aspect of this disclosure has the structure in which the plurality of metallic plates are stacked in parallel, and therefore, the wavelength plate can function as a parallel plate waveguide when a terahertz wave is incident on a stacked side plane and can propagate the incident wave at low loss. At this time, a polarization component (horizontally polarized light) of the incident wave which is parallel to (perpendicular to the stacking direction) the metallic plate receives a phase change. Furthermore, each of the metallic plates constituting the wavelength plate has a periodic structure, and therefore, a polarization component of the incident wave (longitudinally polarized light) of the incident wave which is perpendicular to (parallel to the stacking direction) the metallic plate also receives a phase change when propagated in the wavelength plate. The difference in the amount of phase change which the horizontally polarized light and the longitudinally polarized light receive is almost constant over the wide band, and the difference in the amount of phase change can be determined by the gap between the stacked metallic plates and the periodic structure possessed by the metallic plates. Accordingly, according to this disclosure, it is possible to realize the wavelength plate of the terahertz wave band which can be operated in the wide band with low insertion loss.

In order to obtain the above-described effect, it is preferable that the terahertz band wavelength plate employs the following configuration.
A configuration in which a plurality of metallic plates are disposed in parallel while facing each other, each of the metallic plates has a periodic structure, and when an incident wave is incident, a surface plasmon is excited on the metallic plates by the periodic structure.
The periodic structure may be a circular opening or a concave/convex shape in a terahertz wavelength order.
The circular opening may be periodically formed over the entire metallic plate.
The incident wave may be a terahertz wave, and a phase delay may be caused between a polarization component parallel to the metallic plates and a polarization component perpendicular to the metallic plates with respect to the terahertz wave.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A terahertz band wavelength plate comprising:
a first metallic plate; and
a second metallic plate which is disposed opposite the first metallic plate,
wherein at least one of the first and second metallic plates has a periodic dielectric constant distribution in which a plasmon is excited.

2. The terahertz band wavelength plate according to claim 1,
wherein at least one of the first and second metallic plates excites a surface plasmon on at least one of the first and second metallic plates using a terahertz wave incident on an area between the first metallic plate and the second metallic plate, and imparts a predetermined phase difference between a polarization component parallel to the first and second metallic plates and a polarization component perpendicular to the first and second metallic plates to the terahertz wave incident on the area between the first metallic plate and the second metallic plate so as to emit the terahertz wave.

3. The terahertz band wavelength plate according to claim 2, further comprising:
at least one metallic plate which is stacked parallel to the first metallic plate and the second metallic plate,
wherein gaps between the first metallic plate, the second metallic plate, and the at least one metallic plate which is further stacked are constant.

4. The terahertz band wavelength plate according to claim 2,
wherein the predetermined phase difference is π.

5. The terahertz band wavelength plate according to claim 2,
wherein the predetermined phase difference is π/2.

6. A terahertz wave measurement device comprising:
the terahertz band wavelength plate according to claim 5,
wherein an incident optical axis of a terahertz wave incident on an object to be measured and an emission optical axis of a terahertz wave reflected from the object to be measured are coaxial.

7. A terahertz band wavelength plate,
wherein a plurality of metallic plates are disposed in parallel while facing each other, and each of the metallic plates has a periodic structure, and
wherein when an incident wave is incident, a surface plasmon is excited on the metallic plates by the periodic structure.

8. The terahertz band wavelength plate according to claim 7,
wherein the periodic structure is a circular opening or a concave/convex shape in a terahertz wavelength order.

9. The terahertz band wavelength plate according to claim 8,
wherein the circular opening is periodically formed over the entire metallic plate.

10. The terahertz band wavelength plate according to claim 7,
wherein the incident wave is a terahertz wave, and a phase delay is caused between a polarization component parallel to the metallic plates and a polarization component perpendicular to the metallic plates with respect to the terahertz wave.
